(19) United States
(12) Patent Application Publication
(10) Pub. No.: US 2024/0279397 A1
(43) Pub. Date: Aug. 22, 2024

(54) BIO-SOURCED CATIONIC HIGH CHARGE DENSITY POLYMER

(71) Applicant: SNF Group, ANDREZIEUX BOUTHEON (FR)

(72) Inventors: Cédrick FAVERO, ANDREZIEUX BOUTHEON (FR); Johann KIEFFER, ANDREZIEUX BOUTHEON (FR)

(21) Appl. No.: 18/565,662

(22) PCT Filed: Jul. 8, 2022
(86) PCT No.: PCT/EP2022/069132

§ 371 Date: Nov. 30, 2023

(30) Foreign Application Priority Data
Jul. 9, 2021 (FR) 2107502

(51) Int. Cl. C08G 73/02; C04B 20/02; C04B 24/28

(52) U.S. Cl. CPC C08G 73/022; C04B 20/023; C04B 24/28

(57) ABSTRACT

A bio-sourced cationic polymer is obtained by reaction of epihalohydrin that is least partially renewable and non-fossil, and at least one compound of formula (R¹)₂N(CH₂CH₂NH)ₙ(CH₂CH₂N(R²)₂)ₘ that is at least partially renewable and non-fossil. R¹ and R² are, independently of one another, a hydrogen atom H or an alkyl chain including 1 to 8 carbon atoms, n=0 to 3, m=0 or 1. When n=m=0, then a hydrogen atom H is covalently bound to the nitrogen atom N of the N(R¹)₂ group.

### FIELD OF THE INVENTION

The present invention relates to a bio-sourced cationic high charge density polymer. The polymer according to the invention is obtained from bio-sourced epihalohydrin and at least one other bio-sourced compound. The invention also relates to a method for manufacturing the bio-sourced cationic high charge density polymer, and the use thereof in various technical fields.

### PRIOR ART

Water-soluble cationic high charge density polymers are known to the person skilled in the art and can be obtained by various methods. One example is the polycondensation reaction of di-functional amino compounds, such as alkylene amines, or primary or secondary monoamines with a di-functional compound selected from di-epoxides, epihalohydrins or di-halogen compounds.

In order to meet the cationic high charge density criterion, it is known from documents U.S. Pat. Nos. 3,738,945 and 3,725,312 to preferentially use monomeric entities with the lowest possible molecular weight; ammonia or mono- or di-alkylated amines being the preferred entities. However, the use of ammonia or mono-alkylated amines results in structured and highly branched polymers, even if their viscosity is less than 200 cps, whose cationic charges are sterically hardly accessible, giving these branched structures little industrial interest.

Thus, in order to obtain linear polymers of lower molecular weight or with low branching, the person skilled in the art preferentially uses di-alkylated amines, the preferred one being dimethylamine. For the polycondensation reaction, epihalohydrins, and preferably epichlorohydrin, are generally preferred to di-epoxides, as they are of lower molecular weight and thus allow cationic polymers with higher cationic charge density.

The use of dihalogenated compounds such as dichloroethane is also known and described in document U.S. Pat. No. 4,057,580 for the preparation of cationic high charge density polymers. However, the polymers obtained are very branched, and dichloroethane is derived from the chlorination of fossil-based ethylene.

The person skilled in the art also knows the radical polymerization reactions of at least one ethylenic monomer comprising a quaternary ammonium function, with the possibility of the latter being chosen from acrylamidopropyltrimethyl ammonium chloride (APTAC), methacrylamidopropyltrimethyl ammonium chloride (MAPTAC), dimethylaminoethyl acrylate (ADAME) or dimethylaminoethyl methacrylate (MADAME), all of which compounds are quaternized with halogenated alkyl derivatives or dialkyl sulfates. However, the polymers obtained have limited cationic charge densities.

Another method for preparing water-soluble cationic polymers of high cationic charge density known to the person skilled in the art is the radical polymerization reaction of at least one allylic monomer, such as a diallyldialkylammonium halide. Among the allylic monomers, diallyldimethyl ammonium halides allow to obtain polymers with the highest charge density, the most accessible allylic monomer on the market being diallyldimethyl ammonium chloride (DADMAC).

In particular, DADMAC homopolymers are characterized by cationic charge densities that are however limited to 6.2 meq/g. Diallyldimethylammonium chloride is obtained by reaction of dimethylamine and allyl chloride. The latter is derived from chlorination of propylene.

Propylene is a fossil-based olefin, and is currently produced by steam cracking of naphtha, itself derived from crude oil refining. More recently, and with the advent of shale gas production, various propane dehydrogenation methods to produce propylene have been described.

Fossil-based propylene contains various impurities, which remain or are transformed in the method for producing allyl chloride and thus diallyldimethyl ammonium chloride.

The problem the invention proposes to resolve is to provide a new bio-sourced cationic high charge density polymer, and an improved method for obtaining said polymer.

### SUMMARY OF THE INVENTION

Quite surprisingly, the applicant has observed that the use of epihalohydrin that is at least partially renewable and non-fossil, and of at least one formula (I) compound that is at least partially renewable and non-fossil, allows to obtain a bio-sourced cationic high charge density polymer. The method for obtaining said polymer is also improved.

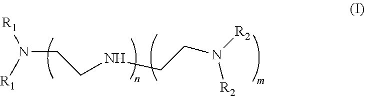

Such that:
R₁ and R₂ are, independently of each other, a hydrogen atom H or an alkyl chain comprising 1 to 8 carbon atoms, preferably a linear alkyl chain n=0 to 3, m=0 or 1.

Where n=m=0, then a hydrogen atom H is covalently bonded to the nitrogen atom N of the NR₁R₁ group.

In the whole invention, the epihalohydrin is preferentially epichlorohydrin.

In the whole invention, the formula (I) compound preferentially comprises dialkylamine, more preferentially dimethylamine or an ethylene amine, more preferentially ethylene diamine, or a compound mixture of at least two formula (I) compounds, preferentially a mixture of dimethylamine and ethylene diamine.

The bio-sourced cationic high charge density polymer preferentially comprises a polyamine.

Without seeking to be bound by any particular theory, the Applicant raises the possibility that the different nature of the impurities between fossil-based epihalohydrin and renewable and non-fossil-based epihalohydrin, and/or between the at least fossil-based formula (I) compound and the at least renewable and non-fossil formula (I) compound is the cause of these unexpected technical effects.

The first object of the invention is a bio-sourced cationic polymer obtained by reaction of epihalohydrin that is at least partially renewable and non-fossil and at least one formula (I) compound that is at least partially renewable and non-fossil. In other words, the reaction between:
epihalohydrin that is at least partially renewable and non-fossil, and
at least one formula (I) compound that is at least partially renewable and non-fossil, affords the bio-sourced cationic polymer.

The polymer according to the invention is prepared as follows, wherein epichlorohydrin and dimethylamine are used in order to illustrate the polymer, without limiting the scope of the invention:

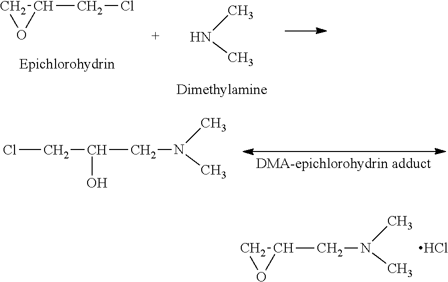

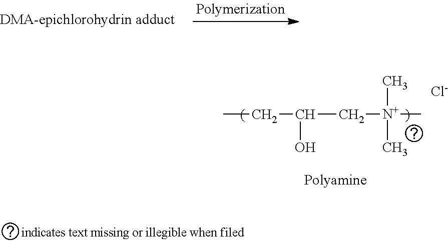

A further object of the invention is using the polymer according to the invention in various technical fields.

With the present invention, it is possible to achieve environmental objectives inherent in new technical innovations. The use of renewable and non-fossil raw material allows to substantially optimize the method. It also allows to obtain polymers which deliver unexpectedly improved performances.

The Applicant has observed that the amount of residual impurities is lower for the cationic polymer obtained by reaction of epihalohydrin at least partly renewable and non-fossil, and a compound of formula (I) at least partly renewable and non-fossil, than for the polymer of fossil origin. The Applicant has also observed that the amount of impurity decreases proportionally to the amount of bio-sourced compound.

The Applicant has also observed that, under the same polymerization conditions, the cationic polymers obtained from epihalohydrin, at least partly renewable and non-fossil, and a compound of formula (I) at least partly renewable and non-fossil, have a higher average molecular weight than cationic polymers of fossil origin.

The Applicant has also observed that, under the same polymerization conditions, the cationic polymers obtained from epihalohydrin at least partly renewable and non-fossil and from a compound of formula (I) at least partly renewable and non-fossil are better coagulants than the cationic polymers of fossil origin.

### DETAILED DESCRIPTION OF THE INVENTION

In the context of the invention, the terms “renewable and non-fossil” are used to designate the origin of a chemical compound derived from biomass or from synthesis gas (syngas), i.e. resulting from one or more chemical transformations carried out on one or more natural and non-fossil raw materials. The terms “bio-sourced” or “bio-resourced” can also be used to characterize the renewable and non-fossil origin of a chemical compound. The renewable and non-fossil origin of a compound includes renewable and non-fossil raw materials stemming from the circular economy, which have been previously recycled, once or several times, in a biomass material recycling process, such as materials from polymer depolymerization or pyrolysis oil processing.

According to the invention, the “at least partially renewable and non-fossil” quality of a compound means a bio-sourced carbon content preferably between 5 wt % and 100 wt % relative to the total carbon weight of said compound.

In the context of the invention, the ASTM D6866-21 standard Method B is used to characterize the bio-sourced nature of a chemical compound and to determine the bio-sourced carbon content of said compound. The value is expressed as a weight percentage (wt %) of bio-sourced carbon relative to the total carbon weight in said compound.

The ASTM D6866-21 standard is a test method that teaches how to experimentally measure the bio-sourced carbon content of solids, liquids and gaseous samples by radiocarbon analysis.

This standard primarily uses Accelerator Mass Spectrometry (AMS) technology. This technique is used to naturally measure the radionuclides present in a sample, wherein the atoms are ionized, then accelerated to high energies, then separated, and individually counted in Faraday cups. This high-energy separation is extremely effective at filtering out isobaric interference, so that AMS is able to accurately measure abundances of carbon-14 relative to carbon-12 (14C/12C) to an accuracy of 1.10-15.

The ASTM D6866-21 standard Method B uses AMS and IRMS (Isotope Ratio Mass Spectroscopy). The test method allows to directly differentiate contemporary carbon-based carbon atoms from fossil-based carbon atoms. A measure of the carbon-14 to carbon-12 or carbon-14 to carbon-13 content of a product is determined against a modern carbon-based reference material accepted by the radiocarbon dating community such as the NIST's Standard Reference Material (SRM) 4990C (oxalic acid).

The sample preparation method is described in the standard and does not require any special comment as it is a commonly used procedure.

Analysis, interpretation and reporting of results are described below. Isotope ratios of carbon-14 to carbon-12 content or carbon-14 to carbon-13 content are measured using AMS. Isotope ratios of carbon-14 to carbon-12 content or carbon-14 to carbon-13 content are determined relative to a standard traceable via the NIST SRM 4990C modern reference standard. The “fraction of modern” (fM) represents the amount of carbon-14 in the tested product relative to the modern standard. It is most often referred to as percent modern carbon (pMC), the percentage equivalent to fM (e.g. fM 1=100 pMC).

All pMC values obtained from radiocarbon analyses must be corrected for isotopic fractionation using a given stable isotope. The correction should be made using the carbon-14 to carbon-13 values determined directly using the AMS where possible. If this is not possible, the correction should be made using the delta 13C (813C) measured by IRMS, CRDS (Cavity Ring Down Spectroscopy) or any other equivalent technology that can provide accuracy to within plus or minus 0.3 per thousand.

“Zero pMC” represents the total absence of measurable 14C in a material above the background signals, thus indicating a fossil (e.g. petroleum-based) carbon source. A value of 100 pMC indicates a fully “modern” carbon source. A pMC value between 0 and 100 indicates a proportion of carbon derived from a fossil source relative to a “modern” source.

The pMC may be higher than 100% due to the persistent, but diminishing, effects of 14C injection into the atmosphere caused by atmospheric nuclear testing programmes. The pMC values need to be adjusted by an atmospheric correction factor (REF) to obtain the actual bio-sourced content of the sample.

The correction factor is based on the excess 14C activity in the atmosphere at the time of testing. A REF value of 102 pMC was determined for 2015 based on CO₂ measurements in the air in a rural area of the Netherlands (Lutjewad, Groningen). The first version of this standard (ASTM D6866-04) in 2004 had referenced a value of 107.5 pMC, while the later version ASTM D6866-10 (2010) had referenced a value of 105 pMC. These data points represent a drop of 0.5 pMC per year. Consequently, on 2 January of each year, the values in Table 1 below were used as REF value until 2019, reflecting the same decrease of 0.5 pMC per year. The REF values (pMC) for 2020 and 2021 have been determined to be 100.0 based on continuous measurements in the Netherlands (Lutjewad, Groningen) until 2019. References for reporting carbon isotope ratio data are provided below for 14C and 13C, respectively Roessler, N., Valenta, R. J., and van Cauter, S., “Time-resolved Liquid Scintillation Counting”, Liquid Scintillation Counting and Organic Scintillators, Ross, H., Noakes, J. E., and Spaulding, J. D., Eds., Lewis Publishers, Chelsea, M I, 1991, pp. 501-511. Allison, C. E., Francy, R. J., and Meijer, H. A. J., “Reference and Intercomparison Materials for Stable Isotopes of Light Elements”, International Atomic Energy Agency, Vienna, Austria, IAEATECHDOC—825, 1995.

The percentage of the bio-sourced carbon content is calculated by dividing pMC by REF and multiplying the result by 100. For example, [102 (pMC)/102 (REF)]×100=100% bio-sourced carbon. The results are indicated as a weight percentage (wt %) of bio-sourced carbon relative to the total carbon weight in said compound.

TABLE 1
Reference of percentage of modern carbon (pMC)

| REF year | pMC |
|---|---|
| 2015 | 102.0 |
| 2016 | 101.5 |
| 2017 | 101.0 |
| 2018 | 100.5 |
| 2019 | 100.0 |
| 2020 | 100.0 |
| 2021 | 100.0 |

In the context of the invention, the term “segregated” means a material stream that is distinctive and distinguishable from other material streams in a value chain (e.g. in a product manufacturing method), and thus considered to belong to a set of materials having an equivalent nature, such that the same origin of the material, or its manufacture according to the same standard or norm, can be tracked and guaranteed throughout this value chain.

For example, this may be the case of a chemist buying 100% bio-sourced epihalohydrin exclusively from a single supplier who guarantees the 100% bio-sourced origin of the epihalohydrin delivered, and said chemist processing this 100% bio-sourced epihalohydrin separately from other potential epihalohydrin sources to produce a chemical compound. If the chemical compound produced is made solely from said 100% bio-sourced epihalohydrin, then the chemical compound is 100% bio-sourced.

In the context of the invention, the term “non-segregated”, in contrast to the term “segregated”, is understood to mean a material stream that cannot be differentiated from other material streams in a value chain.

In order to better understand this notion of segregation, it is useful to recall some basics about the circular economy and its practical application in methods, especially chemical transformation.

According to the French Environment and Energy Management Agency (ADEME), the circular economy can be defined as an economic system of trade and production which, at all stages of the life cycle of products (goods and services), seeks to increase efficiency in the use of resources and to reduce the environmental impact while developing the well-being of individuals. In other words, it is an economic system devoted to efficiency and sustainability that minimizes waste by optimizing value generated by resources. It relies heavily on a variety of conservation and recycling practices in order to break away from the current more linear “take-make-dispose” approach.

In the field of chemistry, which is the science of transforming one substance into another, this translates into reusing material that has already been used to make a product. Theoretically, all chemicals can be isolated and therefore recycled separately from other chemicals. The reality, particularly in industry, is more complex and means that even when isolated, the compound cannot often be differentiated from the same compound originating from another source, thus complicating the traceability of the recycled material.

For this reason, various traceability models have been developed taking into account this industrial reality, thereby allowing users in the chemical industry to manage their material streams with full knowledge of the facts, and allowing end customers to understand and know in a simple way the origin of the materials used to produce an object or a commodity.

These models have been developed to build transparency and trust throughout the value chain. Ultimately, this allows end-users or customers to choose a more sustainable solution without having the ability themselves to control every aspect of the method, by knowing the proportion of a desired component (e.g. of a bio-sourced nature) in an object or commodity.

One such model is “segregation”, which we have defined earlier. Some known examples where this model applies are glass and some metals where it is possible to track material streams separately.

However, chemicals are often used in complex combinations, and separate cycles are very often difficult to implement, especially due to prohibitive costs and highly complex stream management, such that the “segregation” model is not always applicable.

Consequently, when it is not possible to differentiate between material streams, other models are applied, which are grouped together under the term “non-segregated” and which entail, for example, taking into account the proportion of a specific stream relative to other streams, without physically separating the streams. One example is the Mass Balance Approach.

The Mass Balance Approach involves accurately tracking the proportion of a category (e.g. “recycled”) relative to a whole in a production system in order to guarantee, on the basis of an auditable account ledger, a proportionate and appropriate allocation of the content of that category in a finished product.

For example, this may be the case of a chemist buying 50% bio-sourced epihalohydrin from a supplier who guarantees, according to the mass or weight balance approach, that in the epihalohydrin delivered, 50% of the epihalohydrin has a bio-sourced origin, and de facto 50% is not of bio-sourced origin, and the use by said chemist of this 50% bio-sourced epihalohydrin with another stream of 0% bio-sourced epihalohydrin, the two streams not being identifiable at some point during the production process, due to mixing for example. If the chemical compound produced is made from 50% bio-sourced 50 wt % guaranteed epihalohydrin, and 0% bio-sourced 50 wt % epihalohydrin, the chemical compound is 25% bio-sourced.

In order to guarantee the stated “bio-sourced” FIGURES, for example, and to encourage the use of recycled raw materials in producing new products, a set of globally shared and standardised rules (ISCC+, ISO 14020) has been developed to reliably manage material streams.

In the context of the invention, the term “recycled” is understood to mean the origin of a chemical compound derived from a method for recycling a material considered as waste, i.e. resulting from one or more transformations carried out using at least one recycling method on at least one material generally considered as waste.

The term “water-soluble polymer” is understood to mean a polymer which gives a clear aqueous solution when dissolved by stirring at 25° C. and with a concentration of 20 g·L⁻¹ in water.

Polymer According to the Invention

The present invention relates to a bio-sourced cationic polymer obtained by reaction of epihalohydrin that is at least partially renewable and non-fossil and at least one formula (I) compound that is at least partially renewable and non-fossil,

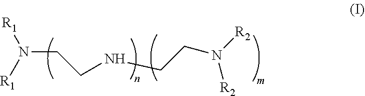

such that:
R₁ and R₂ are, independently of each other, a hydrogen atom H or an alkyl chain comprising 1 to 8 carbon atoms,
n=0 to 3, m=0 or 1.

Where n=0, m=0, the formula (I) compound is an amine NR₁R₁H.

Preferably, R₁=CH₃, n=0, m=0. In this particular case, a hydrogen H is covalently bonded to the nitrogen N, which corresponds to dimethylamine.

Preferentially, R₁, R₂=H, n=0, m=1. This case corresponds to ethylenediamine.

Alternatively, R₁, R₂=H, n=1, 2 or 3, m=1. These different cases correspond respectively to diethylenetriamine, triethylenetetramine, tetraethylenepentamine.

According to the invention, the epihalohydrin that is at least partially renewable and non-fossil reacts with the formula (I) compound that is at least partially renewable and non-fossil, to form the bio-sourced cationic polymer.

According to an embodiment of the invention, the bio-sourced cationic polymer consists of the epihalohydrin that is at least partially renewable and non-fossil and the formula (I) compound that is at least partially renewable and non-fossil. This means that the epihalohydrin and the formula (I) compound are the only monomers involved in the reaction forming the polymer.

In the whole invention, the formula (I) compound preferentially comprises a dialkylamine, more preferentially dimethylamine, or an ethylene amine, more preferentially ethylene diamine or tetraethylene pentamine, or a mixture of at least of the compounds thereof. The order of preference is dimethylamine, a mixture of dimethylamine and ethylene diamine, and then tetraethylene pentamine.

Where a mixture of dimethylamine and ethylene diamine is used, the molar percentage of dimethylamine, expressed with respect to the total amount of dimethylamine and ethylene diamine, is preferably between 90% and 99.9%, preferably between 90% and 99.5%, more preferentially between 97% and 99%, and the molar percentage of ethylene diamine is preferably greater than 0.1%, preferentially between 0.5% and 10%, more preferentially between 1% and 3%.

In the whole invention, the epihalohydrin preferentially comprises epichlorohydrin.

In the whole invention, the bio-sourced cationic polymer is preferentially a polyamine.

Preferably, the bio-sourced cationic polymer of the invention does not comprise any amide group.

In the present description, the expressions “between X and Y” and “from X to Y” include the terminals X and Y.

In the whole invention, the bio-sourced carbon content of a compound for which it is specified that it is at least partially renewable and non-fossil, or for which the bio-sourced carbon content is specified, relative to the total carbon weight in said compound, ranges from 5 wt % to 100 wt %, and preferably from 10 wt % to 100 wt %, preferably from 15 wt % to 100 wt %, preferably from 20 wt % to 100 wt %, preferably from 25 wt % to 100 wt %, preferably from 30 wt % to 100 wt %, preferably from 35 wt % to 100 wt %, preferably from 40 wt % to 100 wt %, preferably from 45 wt % to 100 wt %, preferably from 50 wt % to 100 wt %, preferably from 55 wt % to 100 wt %, preferably from 60 wt % to 100 wt %, preferably from 65 wt % to 100 wt %, preferably from 70 wt % to 100 wt %, preferably from 75 wt % to 100 wt %, preferably from 80 wt % to 100 wt %, preferably from 85 wt % to 100 wt %, preferably from 90 wt % to 100 wt %, preferably from 95 wt % to 100 wt %, preferably from 97 wt % to 100 wt %, preferably from 99 wt % to 100 wt %, the bio-sourced carbon content being measured according to ASTM D6866-21 Method B.

In the invention and in the various embodiments described hereinafter, the epihalohydrin preferentially has a bio-sourced carbon content ranging between 5 wt % and 100 wt % relative to the total carbon weight in said epihalohydrin, the bio-sourced carbon content being measured according to ASTM D6866-21 Method B.

In the invention and in the various embodiments described hereinafter, the formula (I) compound preferentially has a bio-sourced carbon content ranging between 5 wt % and 100 wt % relative to the total carbon weight in said compound, the bio-sourced carbon content being measured according to ASTM D6866-21 Method B.

In the invention and in the various embodiments described hereinafter, the bio-sourced cationic polymer has a bio-sourced carbon content ranging between 5 wt % and 100 wt % relative to the total carbon weight in said polymer, the bio-sourced carbon content being measured according to ASTM D6866-21 Method B.

In the invention and in the various embodiments described hereinafter, the epihalohydrin is preferentially totally renewable and non-fossil.

In the invention and in the various embodiments described hereinafter, the formula (I) compound is preferentially totally renewable and non-fossil.

The bio-sourced cationic polymer according to the invention is preferentially totally renewable and non-fossil.

The epihalohydrin and/or the formula (I) compound may be non-segregated, partially segregated, or totally segregated.

Where the epihalohydrin and/or the formula (I) compound are totally renewable and non-fossil, they may be:
a) Either totally recycled and
a)1) Or totally segregated;
a)2) Or partially segregated;
a)3) Or non-segregated;
b) Or partially of recycled origin and
b)1) Or totally segregated;
b)2) Or partially segregated;
b)3) Or non-segregated;
c) Or totally of non-recycled origin and
c)1) Or totally segregated;
c)2) Or partially segregated;
c)3) Or non segregated.

In these various embodiments, where the epihalohydrin and/or the formula (I) compound is/are partially segregated, the weight ratio between the “segregated” part and the “non-segregated” part is preferably between 99:1 and 10:90, preferably between 99:1 and 30:70, or more preferably between 99:1 and 50:50.

Among these various embodiments, preference is given to the three a) embodiments, the three b) embodiments, and embodiment c)1). Among these embodiments, much greater preference is given to embodiments a)1), a)2), b)1), b)2) and c)1). The two most preferred embodiments are a)1) and b)1).

The industrial reality is such that it is not always possible to obtain industrial quantities of epihalohydrin and/or the formula (I) compound that are bio-sourced, totally recycled and/or segregated or highly recycled and segregated. Hence, the above preferences may be more difficult to implement at the moment. From a practical standpoint, embodiments a)3), b)3), and c) are currently implemented more easily and on a larger scale. With techniques evolving quickly towards the circular economy, there is no doubt that the already applicable preferred modes will soon be applicable on a very large scale.

Where the epihalohydrin and/or the formula (I) compound is/are partially renewable and non-fossil, a distinction is made between the renewable part (bio-sourced) and the non-bio-sourced part. Obviously, each of these parts can be according to the same embodiments a), b) and c) described hereinabove.

As concerns the bio-sourced part of the partially bio-sourced epihalohydrin and/or the formula (I) compound, the same preferences apply as in the case where the compound is totally bio-sourced.

However, as concerns the non-bio-sourced part of the partially bio-sourced compound, it is even more preferable to have as large a recycled component as possible for a circular economy approach. Hence, in this case, preference is given to embodiments a)1), a)2), b)1), b)2), particularly a)1) and b)1).

In the invention and in the various embodiments described hereinafter, bio-epihalohydrin is obtained from saponification of 1,3 dichloropropanol with a metal hydroxide, typically sodium hydroxide. In a first variant, 1,3-dichloropropanol is obtained by hydrochlorination of glycerol, the latter being obtained from biomass. In a second variant, 1,3-dichloropropanol is obtained by chlorination of allyl chloride, the latter being obtained by chlorination of bio-sourced-propylene.

In the invention and in the various embodiments described hereinafter, the formula (I) compound, and more specifically bio-sourced-dialkylamine, is obtained from the corresponding bio-alcohol and ammonia. For example bio-sourced-dimethylamine is obtained from bio-sourced-methanol and ammonia. In a first variant, where R₁=CH₃, n=0, and m=0, the formula (I) bio-sourced-product, specifically dimethylamine, is obtained by reaction between biomethanol and ammonia. In a second variant, where R₁, R₂=H, n=0, and m=1, the formula (I) bio-sourced-product, namely ethylene diamine, is obtained by reaction between ethylene and ammonium bio-sourced-dichloride. Ethylene dichloride is obtained by chlorination of the bio ethylene.

Another process for obtaining epihalohydrin and/or the formula (I) compound is based on compounds from hydrogenation and/or electroreduction of carbon dioxide (CO₂), said CO₂ being converted into intermediate compounds such as methanol or another alcohol, for example. CO₂ can be derived, for example, from conventional recycling processes or from CO₂ capture technology.

The polymer according to the invention is preferentially obtained according to a method comprising two steps, including a first step wherein epihalohydrin and the formula (I) compound react at a temperature ranging between 5 and 95° C., preferentially between 30 and 80° C., the product of this reaction being an adduct of the formula (I) compound—epihalohydrin, which can be noted [formula (I) compound—epihalohydrin], followed by a second step wherein the said adduct is polymerized at a temperature ranging between 5 and 95° C., preferentially between 30 and 80° ° C., in order to obtain the cationic bio-sourced polymer.

The diagram hereinafter, applied to epichlorohydrin and dimethylamine, shows the first step of the method. The adduct [formula (I) compound—epihalohydrin], noted (a), actually corresponds to two molecules in equilibrium (epichlorohydrin and dimethylamine are used in order to illustrate the polymer, without limiting the scope of the invention).

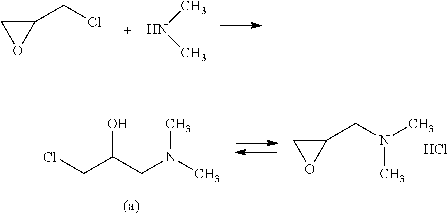

The adduct (a) [formula (I) compound—epihalohydrin] is then polymerized to obtain a cationic polymer (b) shown below, which is preferentially a polyamine.

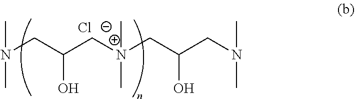

Thus, in a preferred embodiment, the invention relates to a bio-sourced polyamine obtained from epihalohydrin that is at least partially renewable and non-fossil, preferentially epichlorohydrin that is at least partially renewable and non-fossil, and at least one dimethylamine mixture that is at least partially renewable and non-fossil, and ethylenediamine that is at least partially renewable and non-fossil, the molar percentage, expressed relative to the total amount of dimethylamine and ethylenediaminepolyamine being:
at least 90% dimethylamine, preferentially at least 94%, more preferentially between 95% and 99.9%, much more preferentially between 97% and 99%, and
10% or less of ethylene diamine, preferentially 6% or less, more preferentially between 0.1% and 5%, much more preferentially between 1% and 3%.

The cationic density of the polymer according to the invention preferentially ranges between 4 and 7 meq/g, more preferentially between 6 and 7 meq/g.

The cationic polymer according to the invention is preferably water-soluble.

The cationic polymer according to the invention is advantageously linear or branched. When it is branched, it is preferentially slightly branched, and more specifically its level of branching is such that the polymer is soluble in aqueous solution at a concentration greater than 10 g per liter, at 25° C.

According to the invention, the polymer may be in liquid, gel or solid form when its preparation includes a drying step such as spray drying, drum drying, radiation drying, such as microwave drying, or fluid bed drying.

According to the invention, the water-soluble polymer preferentially has a molecular weight ranging between 1000 and 5 million g/mol, preferentially between 50,000 and 2 million g/mol. The polymer may be a dispersant, in which case its molecular weight is preferably between 1000 and 50,000 g/mol. The polymer may have a higher molecular weight, typically between 5 and 30 million g/mol. The molecular weight is understood as weight average molecular weight. The polymer according to the invention may also be a superabsorbent capable of absorbing from 10 to 500 times its weight in water.

The molecular weight is advantageously determined by the intrinsic viscosity of the (co)polymer. The intrinsic viscosity can be measured by methods known to the person skilled in the art and can be calculated from the reduced viscosity values for different (co)polymer concentrations by a graphical method entailing plotting the reduced viscosity values (y-axis) against the concentration (x-axis) and extrapolating the curve down to zero concentration. The intrinsic viscosity value is plotted on the y-axis or using the least squares method. The molecular weight can then be determined using the Mark-Houwink equation:

[η]=K M^{α}
[η] represents the intrinsic viscosity of the (co)polymer determined by the solution viscosity measurement method.
K represents an empirical constant.
M represents the molecular weight of the (co)polymer.
α represents the Mark-Houwink coefficient.
K and α depend on the specific (co)polymer-solvent system.

In a particular embodiment, the polymer according to the invention may be a semi-synthetic and thus semi-natural polymer. In this embodiment, the polymer may be synthesized by copolymerization by total or partial grafting of at least one monomer according to the invention, and at least one natural compound, said natural compound being preferably chosen from starches and their derivatives, polysaccharides and their derivatives, fibers, vegetable gums, animal gums or algal gums, and modified versions thereof. For example, vegetable gums can include guar gum, gum arabic, locust bean gum, gum tragacanth, guanidinium gum, cyanine gum, tara gum, cassia gum, xanthan gum, ghatti gum, karaya gum, gellan gum, cyamopsis tetragonoloba gum, soy gum, or beta-glucan or dammar. The natural compound can also be gelatin, casein, or chitosan. For example, algal gum can include sodium alginate or its acid, agar-agar, or carrageenan.

Polymerization is generally carried out, without this being limiting, by copolymerization or by grafting. The person skilled in the art will be able to refer to established knowledge in the field of semi-natural polymers.

The invention also relates to a composition comprising at least one polymer according to the invention and at least one natural polymer, said natural polymer being preferably chosen from the previously described natural polymers. The weight ratio between the synthetic polymer and the natural polymer is generally between 90:10 and 10:90. The composition may be in liquid, inverse emulsion or powder form.

In a particular embodiment, the epihalohydrin and/or the formula (I) compound are derived at least partially, or totally from a recycling method.

In this particular embodiment, epihalohydrin and/or the formula (I) compound are obtained using a recycling method, such as from polymer depolymerization or by manufacturing from pyrolysis oil, the latter resulting from high-temperature, anaerobic combustion of used plastic waste.

Thus, materials considered as waste can be used as a source to produce recycled epihalohydrin and/or the formula (I) compound, which in turn can be used as raw material to manufacture the invention's monomer.

In this particular embodiment, the polymer according to the invention is obtained by a method comprising the following steps:
recycling at least one material that is at least partially renewable and non-fossil to obtain epihalohydrin and the formula (I) compound,
Reacting in a first step the epihalohydrin and the formula (I) compound at a temperature ranging between 5 and 95° C., preferentially between 30 and 80° C., the product of this reaction being a formula (I) compound adduct—epihalohydrin,
Polymerizing said adduct obtained at a temperature ranging between 5 and 95° C., preferentially between 30 and 80° ° C., to obtain the bio-sourced cationic polymer.

The recycling rate is the weight ratio of the recycled material to the total material.

In this embodiment, the part obtained from recycling is preferably totally “segregated”, i.e. is obtained from a separate pipeline and is treated in a separate manner. In an alternative embodiment, it is partially “segregated” and partially “non-segregated”. In this case, the weight ratio between the “segregated” part and the “non-segregated” part is preferably between 99:1 and 10:90, preferably between 99:1 and 30:70, or more preferably between 99:1 and 50:50.

Method According to the Invention

The invention relates to a method for obtaining a bio-sourced cationic polymer by reaction of epihalohydrin that is at least partially renewable and non-fossil and at least one formula (I) compound that is at least partially renewable and non-fossil.

The formula (I) compound is preferentially a dialkylamine, more preferentially dimethylamine, or an ethylene amine, more preferentially ethylene diamine or tetraethylene pentamine, or a mixture of at least of the compounds thereof. The order of preference is dimethylamine, a mixture of dimethylamine and ethylene diamine, and then tetraethylene pentamine.

Where a mixture of dimethylamine and ethylene diamine is used, the molar percentage, expressed relative to the total amount of dimethylamine and ethylene diamine, dimethylamine is preferably greater than 90%, preferentially greater than 94%, preferentially ranging between 95% and 99.9%, more preferentially between 97% and 99%, and the molar percentage of ethylene diamine is preferably greater than 0.1%, preferentially between 0.5% and 10%, more preferentially between 1% and 3%.

In the whole invention, the bio-sourced cationic polymer is preferentially a polyamine.

The embodiments and preferences described in the “Polymer” section apply to this “Method” section.

Using the Polymer According to the Invention

The invention also relates to the use of the polymer according to the invention in the recovery of hydrocarbons (oil and/or gas); in drilling and cementing of wells; in the stimulation of hydrocarbon wells (oil and/or gas), for example hydraulic fracturing, conformation, diversion; in the treatment of water in open, closed or semi-closed circuits; in the treatment of fermentation slurry, treatment of sludge; in paper manufacturing; in construction; in wood processing; in hydraulic composition processing (concrete, cement, mortar and aggregates); in the mining industry; in the formulation of cosmetic products; in the formulation of detergents; in textile manufacturing; in battery component manufacturing; in geothermal energy; in sanitary napkin manufacturing; or in agriculture.

The invention also relates to the use of the polymer according to the invention as a flocculant, coagulant, binding agent, fixing agent, viscosity reducing agent, thickening agent, absorbing agent, friction reducing agent, dewatering agent, draining agent, charge retention agent, dehydrating agent, conditioning agent, stabilizing agent, film forming agent, sizing agent, superplasticizing agent, clay inhibitor or dispersant.

Method Using the Polymer According to the Invention

The present invention also relates to the various methods described hereinafter, wherein the polymers of the invention are used to improve application performance.

The invention relates more particularly to a method for processing a hydraulic composition with the invention's polymer.

The invention therefore relates to a method for inerting clays in hydraulic compositions intended for construction. Said method comprises a step of adding to the hydraulic composition or to one of the constituents thereof at least one clay inerting agent, which clay inerting agent is a polymer according to the invention.

Clays can absorb water and cause poor performance of building materials. When the polymer of the invention is used as a clay inhibitor, it allows in particular to avoid the clay swelling which may cause cracks thus weakening any building.

In this clay inerting method, the polymer is preferably a polyamine. The hydraulic composition may be a concrete, cement, mortar or aggregate. The polymer is added to the hydraulic composition or to one of its constituents at a dosage of 2 to 200 ppm of inerting agent relative to the weight of aggregate.

In this method of inerting clays, clays include, but are not limited to 2:1 swelling clays (such as smectite), or 1:1 swelling clays (such as kaolin) or 2:1:1 swelling clays (such as chlorite). The term clay generally refers to magnesium and/or aluminum silicate, including phyllo silicates with a lamellar structure. However, in the present invention, the term clay also includes clays having no such structure, such as amorphous clays.

In this clay inerting method, clays are not limited to only clays absorbing polyoxyalkylene superplasticizers (ethylene oxide and/or propylene oxide containing compounds), as described in document U.S. Pat. No. 6,352,952, but also include all clays that affect the properties of building materials. Without being limited to a particular list, they include clays generally present in sand, such as montmorillonite, illite, kaolinite or muscovite.

The invention also relates to a method for enhanced oil or gas recovery by sweeping a subterranean formation comprising the following steps:
a. Preparing an injection fluid from a polymer according to the invention with water or brine,
b. Injecting the injection fluid into a subterranean formation,
c. Sweeping the subterranean formation with the injected fluid,
d. Recovering an aqueous mixture of oil and/or gas.

The invention also relates to a method for hydraulic fracturing of subterranean oil and/or gas reservoirs comprising the following steps:
a. Preparing an injection fluid from a polymer according to the invention, with water or brine, and with at least one proppant,
b. Injecting said fluid into the subterranean reservoir and fracturing at least a portion thereof to recover oil and/or gas.

In the enhanced oil recovery and hydraulic fracturing methods describe hereinabove, the polymer is preferably a high molecular weight polymer (greater than 8 million daltons). It is preferably linear. It is preferably in the form of a powder, an inverse emulsion, a partially dehydrated inverse emulsion, or in the form of a “clear”, i.e. a dispersion of solid polymer particles in an aqueous or oily fluid. The powder form is preferably obtained by gel or spray drying of an inverse emulsion. It also involves a composition comprising an inverse emulsion of a polymer according to the invention and solid particles of a polymer according to the invention.

The invention also relates to a method of stimulation of a subterranean formation comprising the following steps:
a. Preparing an injection fluid from a polymer according to the invention with water or brine,
b. Injecting the injection fluid into a subterranean formation,
c. Partially or totally plugging the subterranean formation with the injected fluid, said plugging being temporary or permanent.

The invention also related a method of drilling and/or cementing a well in a subterranean formation comprising the following steps:
a. Preparing an injection fluid from a polymer according to the invention with water or brine,
b. Injecting said drilling and/or cementing fluid into the subterranean formation via the drill head in at least one step of drilling or cementing a well.

Drilling and cementing a well are two successive steps in creating a well in a subterranean formation. The first step is drilling with the drilling fluid, while the second step is cementing the well with the cementing fluid. The invention also relates to a method of injecting an intermediate fluid (“spacer fluid”) injected between the drilling fluid and the cementing fluid, said intermediate fluid comprising at least one polymer according to the invention. This intermediate fluid prevents contamination between the cementing fluid and the drilling fluid.

When drilling and cementing a well, the polymer according to the invention can be used as a fluid loss additive in well cement compositions in order to reduce fluid loss from the cement compositions to permeable formations or zones into or through which the cement compositions are pumped. In primary cementing, loss of fluid, i.e., water, to permeable formations or subterranean zones can lead to premature gelling of the cement composition, so that bridging the annular space between the permeable formation or zone and the drill string cemented therein prevents the cement composition from being placed along the entire length of the ring.

The invention also relates to a method for manufacturing a sheet of paper, cardboard or the like, whereby, before a sheet is formed, a step is performed entailing adding to a suspension of fibers, at one or more injection points, at least one polymer according to the invention. The polymer may provide dry strength or retention properties or wet strength. It may also improve paper formation, drainage and dewatering capabilities.

The method can be used successfully to manufacture packaging papers and cardboards, coating papers, sanitary and household papers, any type of paper, cardboard or the like.

Retention properties are understood to mean the capability to retain the suspended materials of the paper pulp (fibers, fines, fillers (calcium carbonate, titanium oxide), . . . ) on the forming fabric, thus in the fibrous mat that will make up the final sheet. The mode of action of the retention agents is based on the flocculation of these suspended materials in water. Indeed, the flocs formed are more easily retained on the forming sheet.

The retention of fillers involves retaining specifically the fillers (small mineral species with little affinity with cellulose). Substantial improvement of retention of fillers leads to a clarification of white water by retaining the fillers in the sheet and by increasing its grammage. It also gives the possibility to replace part of the fibers (the most expensive species in the composition of paper, cardboard or similar) with fillers (lower costs) in order to reduce manufacturing costs.

As concerns dewatering (or drainage) properties, it is the capacity of the fibrous mat to evacuate or drain the maximum amount of water so that the sheet dries as quickly as possible, in particular during manufacturing of the sheet.

These two properties (retention and drainage) being intricately linked, one depending on the other, the issue is therefore to find the best compromise between retention and drainage. Generally, the person skilled in the art refers to a retention and drainage agent because these are the same types of products used to improve these two properties.

Fibrous suspension is understood to mean thick pulp or diluted pulp which are composed of water and cellulose fibers. The thick stock, with a dry matter concentration of more than 1% or even more than 3%, is located upstream of the fan pump. The thin stock, with a dry mass concentration of generally less than 1%, is located downstream of the fan pump.

The polymer can be added to the thick stock or to the thin stock. It can be added at the level of the fan pump or the headbox. Preferably, the polymer is added before the headbox.

In the method for making paper, cardboard or the like according to the invention, the polymer according to the invention may be used alone or in combination with a secondary retention agent. Preferably, a secondary retention agent selected from organic polymers and/or inorganic microparticles is added to the fiber suspension.

This secondary retention agent added to the fibrous suspension is advantageously chosen from anionic polymers in the broad sense, which can therefore be (without being limiting) linear, branched, cross-linked, hydrophobic, associative and/or inorganic microparticles (such as bentonite, colloidal silica).

The invention also relates to a method for treating a suspension of solid particles in water resulting from mining or oil sands operations, comprising contacting said suspension with at least one polymer according to the invention. Such a method can be carried out in a thickener, which is a holding zone, generally in the form of a tube section of several meters in diameter with a conical bottom wherein the particles can settle. According to a specific embodiment, the aqueous suspension is transported by means of a pipe to a thickener, and the polymer is added to said pipe.

According to another embodiment, the polymer is added to a thickener that already contains the suspension to be treated. In a typical mineral processing operation, the suspensions are often concentrated in a thickener. This results in a higher density sludge that exits the bottom of the thickener, and an aqueous fluid released from the treated suspension (called liquor) that exits by overflow, from the top of the thickener. Generally, the addition of the polymer increases the concentration of the sludge and increases the clarity of the liquor.

According to another embodiment, the polymer is added to the particulate suspension during transport of said suspension to a deposition area. Preferably, the polymer is added in the pipe that conveys said suspension to a deposition zone. It is on this deposition area that the treated suspension is spread in preparation for dewatering and solidification. The deposition areas can be either open, such as an unconfined area of soil, or enclosed, such as a basin, cell.

An example of such treatments during transport of the suspension is spreading the suspension treated with the polymer according to the invention on the soil in preparation for dewatering and solidification and then spreading a second layer of treated suspension on top of the solidified first layer. Another example is the continuous spreading of the suspension treated with the polymer according to the invention in such a way that the treated suspension falls continuously on the suspension previously discharged in the deposition area, thus forming a mass of treated material from which water is extracted.

According to another embodiment, the water-soluble polymer is added to the suspension and a mechanical treatment is performed, such as centrifugation, pressing or filtration.

The water-soluble polymer can be added simultaneously in different stages of the suspension treatment, i.e., for example, in the pipe carrying the suspension to a thickener and in the sludge exiting the thickener which will be conveyed either to a deposition area or to a mechanical treatment device.

The invention also relates to a method for treating municipal or industrial water, comprising the introduction into said water to be treated of at least one polymer according to the invention. Effective water treatment requires the removal of dissolved compounds, and dispersed and suspended solids from the water. Generally, this treatment is enhanced by chemicals such as coagulants and flocculants. These are usually added to the water stream ahead of the separation unit, such as flotation and sedimentation.

The polymers according to the invention can be advantageously used to coagulate or flocculate suspended particles in municipal or industrial wastewater. Generally, they are used in combination with inorganic coagulants such as alum.

They can also be used advantageously to treat the sludge produced from the treatment of this wastewater. Sewage sludge (be it urban or industrial) is the main waste produced by a treatment plant from liquid effluents. Generally, sludge treatment involves dewatering it. This dewatering can be performed by centrifugation, filter press, belt press, electro-dewatering, sludge drying reed beds, solar drying. It is used to decrease sludge water concentration.

In this municipal or industrial water treatment process, the polymer according to the invention is preferably linear or branched. It is preferably in the form of a powder, an inverse emulsion or a partially dehydrated inverse emulsion. The powder form is preferably obtained by gel or spray drying from an inverse emulsion.

The invention also relates to an additive for a cosmetic, dermatological or pharmaceutical composition, said additive comprising at least one polymer according to the invention. The invention also relates to the use of the polymer according to the invention in manufacturing said compositions as a thickening (agent), conditioning (agent), stabilizing (agent), emulsifying (agent), fixing (agent) or film-forming agent. The invention equally relates to cosmetic, dermatological or pharmaceutical compositions comprising at least one polymer according to the invention.

In particular, reference may be made to application FR2979821 on behalf of L'OREAL for the manufacture of such compositions and description of the other ingredients of such compositions. The said compositions may be in the form of a milk, a lotion, a gel, a cream, a gel cream, a soap, a bubble bath, a balm, a shampoo or a conditioner. The use of said compositions for the cosmetic or dermatological treatment of keratinous materials, such as the skin, scalp, eyelashes, eyebrows, nails, hair and/or mucous membranes is also an integral part of the invention. Such use comprises application of the composition to the keratinous materials, possibly followed by rinsing with water.

The invention also relates to an additive for detergent composition, said additive comprising at least one polymer according to the invention. The invention also relates to the use of the polymer according to the invention in manufacturing said compositions as a thickening (agent), conditioning (agent), stabilizing (agent), emulsifying (agent), fixing (agent) or film-forming agent. The invention equally relates to detergent compositions for household or industrial use comprising at least one polymer according to the invention. In particular, reference may be made to the applicant's application WO 2016020622 for the manufacture of such compositions and description of the other ingredients of such compositions.

“Detergent compositions for household or industrial use” are understood to mean compositions for cleaning various surfaces, particularly textile fibers, hard surfaces of any kind such as dishes, floors, windows, wood, metal or composite surfaces. Such compositions include, for example, detergents for washing clothes manually or in a washing machine, products for cleaning dishes manually or for dishwashers, detergent products for washing house interiors such as kitchen elements, toilets, furnishings, floors, windows, and other cleaning products for universal use.

The polymer used as an additive, e.g., thickener, for a cosmetic, dermatological, pharmaceutical, or detergent composition is preferably cross-linked. It is preferably in the form of a powder, an inverse emulsion or a partially dehydrated inverse emulsion. The powder form is preferably obtained by spray drying from an inverse emulsion.

The invention equally relates to a thickener for pigment composition used in textile printing, said thickener comprising at least one polymer according to the invention. The invention also relates to a textile fiber sizing agent, said agent comprising at least one polymer according to the invention.

The invention also relates to a process for manufacturing superabsorbent from the monomer according to the invention, a superabsorbent obtained from at least one monomer according to the invention, said superabsorbent to be used for absorbing and retaining water in agricultural applications or for absorbing aqueous liquids in sanitary napkins. For example, the superabsorbent agent is a polymer according to the invention.

The invention also relates to a method for manufacturing sanitary napkins wherein a polymer according to the invention is used, for example as a superabsorbent agent.

The invention also relates to the use of the polymer according to the invention as a battery binder. The invention also relates to a battery binder composition comprising the polymer according to the invention, an electrode material and a solvent. The invention also relates to a method for manufacturing a battery comprising making a gel comprising at least one polymer according to the invention and filling same into said battery. Mention may be made of lithium ion batteries which are used in a variety of products, including medical devices, electric cars, aircraft and, most importantly, consumer products such as laptops, cell phones and cameras.

Generally, lithium ion batteries (LIBs) include an anode, a cathode, and an electrolyte material such as an organic solvent containing a lithium salt. More specifically, the anode and cathode (collectively, the “electrodes”) are formed by mixing an electrode active material (anode or cathode) with a binder and solvent to form a paste or sludge that is then applied and dried onto a current collector, such as aluminum or copper, to form a film on the current collector. The anode and cathode are then stacked and wound before being housed in a pressurized case containing an electrolyte material, all of which together form a lithium-ion battery.

In a lithium battery, the binder plays several important roles in both mechanical and electrochemical performance. Firstly, it helps disperse the other components in the solvent during the manufacturing process (some also act as a thickener), thus allowing for even distribution. Secondly, it holds the various components together, including the active components, any conductive additives, and the current collector, ensuring that all of these parts stay in contact. Through chemical or physical interactions, the binder connects these separate components, holding them together and ensuring the mechanical integrity of the electrode without a material impact on electronic or ionic conductivity. Thirdly, it often serves as an interface between the electrode and the electrolyte. In this role, it can protect the electrode from corrosion or the electrolyte from depletion while facilitating ion transfer across this interface.

Another important point is that the binders must have a certain degree of flexibility so that they do not crack or develop defects. Brittleness can create problems during manufacturing or assembly of the battery.

Given all the roles it plays in an electrode (and in the battery as a whole), choosing a binder is critical in ensuring good battery performance.

The invention also relates to a method for manufacturing sanitary napkins wherein a polymer according to the invention is used, for example as a superabsorbent agent.

As previously described, the circular economy is an economic system devoted to efficiency and sustainability that minimizes waste by optimizing value generated by resources. It relies heavily on a variety of conservation and recycling practices in order to break away from the current more linear “take-make-dispose” approach.

Therefore, with material recycling being a major and growing concern, recycling processes are developing rapidly and enabling the production of materials that can be used to produce new compounds or objects. Recycling materials does not depend on the origin of the material and as long as it can be recycled, it is considered as a technical progress. Although the origin of the material to be recycled may be renewable or non-fossil, it may also be fossil.

Specific objects are described hereinafter.

A first object relates to a cationic polymer obtained by reaction of epihalohydrin and the formula (I) compound, said compound being derived at least partially, said epihalohydrin and/or said formula (I) compound being partially, preferably totally, derived from a recycling process of a renewable and non-fossil material, or a fossil material.

Preferentially, the epihalohydrin and/or said formula (I) compound is totally “segregated”, i.e., originating from a separate pathway and processed separately. In an alternative embodiment, they are partially “segregated”, and partially “non-segregated”. In this case, the weight ratio between the “segregated” part and the “non-segregated” part of the epihalohydrin and the formula (I) compound preferentially ranges between 99:1 and 25:75, preferably between 99:1 and 50:50. In an alternative embodiment they are totally “non-segregated”.

A second object relates to the use of a cationic polymer obtained by reaction of epihalohydrin and the formula (I) compound, said epihalohydrin and/or said formula (I) compound being partially, preferentially totally, derived from a recycling method of a renewable and non-fossil material, or of a fossil material, in oil and/or gas recovery, drilling and cementing of wells, stimulation of oil and gas wells (for example hydraulic fracturing, conformation, diversion), in the treatment of water in open, closed or semi-closed circuits, in the treatment of fermentation slurry, treatment of sludge, in paper manufacturing, in construction, in wood processing, in hydraulic composition processing (concrete, cement, mortar and aggregates), in the mining industry, in the formulation of cosmetic products, in the formulation of detergents, in textile manufacturing, in battery component manufacturing; in geothermal energy; in sanitary napkin manufacturing; or in agriculture.

A third object relates to the use of a cationic polymer obtained by reaction of epihalohydrin and the formula (I) compound, said epihalohydrin and/or said formula (I) compound being partially, preferentially totally, derived from a recycling method of a renewable and non-fossil material, or of a fossil material, as a flocculant, coagulant, binding agent, fixing agent, viscosity reducing agent, thickening agent, absorbing agent, friction reducing agent, dewatering agent, draining agent, charge retention agent, dehydrating agent, conditioning agent, stabilizing agent, film forming agent, sizing agent, superplasticizing agent, clay inhibitor or dispersant.

### EXAMPLES

In the following tests, high charge density bio-sourced cationic polymers are synthesized according to the invention, comprising epihalohydrin at least partly renewable and non-fossil, and a compound of formula (I) at least partly renewable and non-fossil.

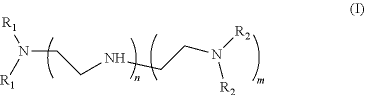

In the examples below, the compound of formula (I) is dimethylamine (hereinafter abbreviated DMA) and the epihalohydrin is epichlorohydrin (hereinafter abbreviated EPI).

Description of the Purity Test

The purity of the bio-sourced cationic polymer is determined by gas chromatography, according to the following conditions:
SPB5 capillary column; 30 meters long, 0.25 mm diameter, 1 μm stationary phase thickness
Injector temperature: 250° C.
Oven: 40° C. for 5 minutes, followed by a ramp of 5° C./min up to 90° C.
Flame ionization detector
Detector temperature: 250° C.
Carrier gas (helium): 13 ml/min
Gas detection: 30 mL/min in H₂ and 400 mL/min in air
Injection volume: 2 μl
Analysis time: 15 min

In the following examples, the high charge density bio-sourced cationic polymer is a polyamine. To determine the purity of a polyamine, a preliminary treatment with dichloromethane in a 1:1 mixture by weight is carried out. The supernatant organic phase is then injected into the gas chromatography equipment.

The purity of the polyamine is indicated by the amount of residual EPI and residual 1,3-dichloro-2-propanol (hereafter abbreviated DCP) present in the product.

PPE retention time is 4 minutes and DCP is 11 minutes 48 seconds.

Through the use of external EPI and DCP standards and by measuring the areas of the various impurity peaks, the purity of the polyamine can be calculated.

### a. Synthesis of Bio-Sourced Cationic Polymers According to the Invention

### I/Synthesis of Bio-Sourced Polyamine According to the Invention

For each of the polymers, the origin of the PPE and/or of the DMA is either 100% fossil, or semi-fossil, or 100% of renewable and non-fossil origin.

Dimethylamine (DMA) of renewable and non-fossil origin comes from bio-sourced-methanol produced from biomass by fermentation or recycling of carbon dioxide (CO₂). Alternatively, the amino fraction of DMA can also be derived from green ammonia.

Epichlorohydrin (EPI) of renewable and non-fossil origin comes from the treatment of residues from the paper pulp industry (hereinafter “tall oil”) in order to form the bio-sourced-propylene precursor before the chlorination process. Alternatively, it can come from the processing of vegetable oil as described in patent WO 2014/111598 or come from glycerol from biomass.

The polymerization process is carried out under the conditions described below. The origins of EPI and DMA are adjusted in the desired proportions (see Table 2).

115 g of demineralised water and 172 g of DMA are added to a 1 L Parr-type pressurized reactor, equipped with a stirred jacket.

The reaction medium is heated using a heating unit supplying the jacket of the reactor until a temperature of 50° C. is reached.

311 g of EPI are then added to the reactor for 90 minutes at 80° C.

A quantity of 20 g of additional PPE is then added to the reactor. At the end of the addition, the reaction medium is maintained at 80° C. for 30 minutes. To stop the reaction medium from setting in viscosity, 25 g of 33% concentrated hydrochloric acid in water are then added. The reactor is then degassed until it reaches atmospheric pressure and is cooled to ambient temperature.

A test set is performed according to the purity test described above by adjusting the origin of the DMA and EPI as well as their percentages of 14C. The 14C level is measured according to the ASTM D6866-21 method B standard. The value is expressed as a percentage by weight of bio-sourced carbon relative to the total weight of carbon in said compound. Thus, the weight percentage of 14C is indicative of the origin of EPI or AMD. A value of zero represents the total absence of measurable 14C in a material, thus indicating a fossil carbon source. Conversely, a value of 100 indicates a carbon source entirely of renewable and non-fossil origin.

The polyamine is analyzed to know the amount of EPI and residual DCP. The higher the quantity, the more difficult the polymerization will be and the final application performance will be impacted.

TABLE 2

| | | wt% of ¹⁴C | | wt% of ¹⁴C in | Residual EPI | Residual DCP |
|---|---|---|---|---|---|---|
| | Origin of EPI | in EPI | Origin of DMA | DMA | (ppm) | (ppm) |
| CE 1 | Fossil | 0 | Fossil | 0 | 43 | 875 |
| P1 | semi-fossil | 30 | semi-fossil | 50 | 22 | 231 |
| | (Tall oil) | | (Biomass) | | | |
| P2 | Not fossil | 100 | semi-fossil | 50 | 5 | 23 |
| | (Glycerol) | | (Biomass) | | | |
| P3 | Semi-fossil | 90 | Non-fossil | 100 | 7 | 33 |
| | (Glycerol) | | (Fermentation) | | | |
| P4 | Semi-fossil | 65 | Semi-fossil | 80 | 16 | 135 |
| | (Tall oil) | | (Fermentation) | | | |
| P5 | Semi-fossil | 80 | Non-fossil | 100 | 9 | 45 |
| | (Vegetable oil) | | (CO₂) | | | |
| P6 | Semi-fossil | 80 | Semi-fossil | 70 | 10 | 89 |
| | (Glycerol) | | (CO₂) | | | |
| P7 | Non-fossil | 100 | Non-fossil | 100 | 3 | 25 |
| | (Glycerol) | | (Biomass + | | | |
| | | | Green ammonia) | | | |

The Applicant has observed that the amount of residual impurities is lower for the cationic polymer obtained by reaction of epichlorohydrin at least partly renewable and non-fossil, and dimethylamine at least partly renewable and non-fossil, than for the polymer of fossil origin.

The amount of impurity decreases proportionally to the amount of bio-sourced compound.

### II/Measurement of the Average Molecular Weight of the Polymers According to the Invention

The average molecular weight of the polymers is determined by measuring the intrinsic viscosity of the polymer.

The intrinsic viscosity can be measured by methods known to the skilled person and can be calculated from the reduced viscosity values for different polymer concentrations by a graphical method consisting in noting the reduced viscosity values (y-axis) on the concentration (x-axis) and extrapolate the curve to zero concentration. The intrinsic viscosity value is plotted on the ordinate axis or using the least squares method.

The molecular weight can then be determined by the Mark-Houwink equation:

[η]=K M^{α}
in which:
   [η] represents the intrinsic viscosity of the polymer determined by the solution viscosity measurement method,
   K represents an empirical constant,
   M represents the molecular weight of the polymer,
   α represents the Mark-Houwink coefficient,
   K and α depend on the particular polymer-solvent system.

TABLE 3

| | wt % of ¹⁴C in polyamine | Molecular weight (g/mol) |
|---|---|---|
| P1 | 38 | 17,000 |
| P2 | 80 | 19,400 |
| P3 | 94 | 24,000 |
| P4 | 75 | 18,000 |
| P5 | 88 | 23,000 |
| P6 | 76 | 21,000 |
| P7 | 100 | 26,000 |
| CE1 | 0 | 14,500 |

The Applicant has observed that, under the same polymerization conditions, the cationic polymers obtained from epichlorohydrin, at least partly renewable and non-fossil, and dimethylamine at least partly renewable and non-fossil, have a higher average molecular weight than cationic polymers of fossil origin.

The use of bio-sourced compounds according to the invention therefore makes it possible to obtain polymers of higher molecular weight.

### b. Use of the Polymer According to the Invention

### III/Jar Test

The polymers P1 to P7 and CE1 are dissolved in water in order to obtain aqueous solutions having a concentration of 0.1% (w/w) by weight of the polymer relative to the total weight of the solution. The solutions are mechanically stirred at 200 rpm until the complete solubilization of the polymers (clear and homogeneous solutions).

A series of coagulation tests is carried out on an aqueous effluent containing 1 g/L of Kaolin, 1 g/L of calcium chloride and 10 g/L of crushed ore (coal).

The tests are carried out in Manual Jar Test according to the following protocol:
Filling the tubes with the effluent;
Injection of a polymeric solution at different dosages;
Realization of 5 reversals of the Jar Test for incorporation of the aqueous polymeric solution in the suspension of the effluent.

The results presented in Table 4 summarize the turbidity of the supernatant according to the dosage of polymer used in relation to the quantity of effluent.

TABLE 4

Polymer dosage (g/ton of effluent)

| | | | |
|---|---|---|---|
| 2 | 4 | 6 | 10 |

| | |
|---|---|
| Polymer | Turbidity (NTU) |

| | | | | |
|---|---|---|---|---|
| P1 | 30 | 17 | 67 | 95 |
| P2 | 29 | 13 | 66 | 89 |
| P3 | 15 | 10 | 58 | 79 |
| P4 | 14 | 11 | 54 | 77 |
| P5 | 24 | 13 | 59 | 81 |
| P6 | 12 | 10 | 50 | 75 |
| P7 | 6 | 9 | 46 | 68 |
| CE 1 | 53 | 30 | 18 | 353 |

The applicant has observed that whatever the dosage, the polymers P1 to P7 have a lower turbidity than the polymer CE1.

Under the same polymerization conditions, the cationic polymers obtained from epichlorohydrin at least partly renewable and non-fossil and from dimethylamine at least partly renewable and non-fossil are better coagulants than the cationic polymers of fossil origin.

1. A bio-sourced cationic polymer obtained by reaction of epihalohydrin that is at least partially renewable and non-fossil and at least one formula (I) compound that is at least partially renewable and non-fossil, 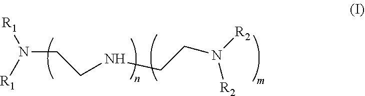
such that:
R₁ and R₂ are, independently of each other, a hydrogen atom H or an alkyl chain comprising 1 to 8 carbon atoms,
n=0 to 3, m=0 or 1, and where n=m=0, then a hydrogen atom H is covalently bonded to the nitrogen atom N of the NR₁R₁ group.

2. The bio-sourced cationic polymer according to claim 1, wherein the epihalohydrin has a bio-sourced carbon content of between 5 wt % and 100 wt % relative to the total carbon weight in said epihalohydrin, the bio-sourced carbon content being measured according to the standard ASTM D6866-21 Method B.

3. The bio-sourced cationic polymer according to claim 1, wherein the formula (I) compound has a bio-sourced carbon content of between 5 wt % and 100 wt % relative to the total carbon weight in the formula (I) compound, the bio-sourced carbon content being measured according to the standard ASTM D6866-21 Method B.

4. The bio-sourced cationic polymer according to claim 1, wherein the bio-sourced cationic polymer has a bio-sourced carbon content of between 5 wt % and 100 wt % relative to the total carbon weight in said polymer, the bio-sourced carbon content being measured according to the standard ASTM D6866-21 Method B.

5. The bio-sourced cationic polymer according to claim 1, wherein the epihalohydrin is epichlorohydrin.

6. The bio-sourced cationic polymer according to claim 1, wherein the formula (I) compound is dimethylamine, or an ethylene amine, or a mixture of at least two of these components; the ethylene amine being preferentially ethylene diamine or tetraethylene pentaminc.

7. The bio-sourced cationic polymer according to claim 1, wherein at least two mutually different formula (I) compounds are used to prepare the bio-sourced cationic polymer, said two formula (I) compounds being dimethylamine and ethylene diamine.

8. The bio-sourced cationic polymer according to claim 7, wherein the molar percentage of dimethylamine, expressed relative to the total amount of dimethylamine and ethylene diamine, ranges between 90% and 99.9%, and in that the molar percentage of ethylene diamine is greater than 0.1%.

9. The bio-sourced cationic polymer according to claim 1, wherein the bio-sourced cationic polymer is a polyamine.

10. The bio-sourced cationic polymer according to claim 1, wherein the epihalohydrin is totally renewable and non-fossil.

11. The bio-sourced cationic polymer according to claim 1, wherein the formula (I) compound is totally renewable and non-fossil.

12. The bio-sourced cationic polymer according to claim 1, wherein the epihalohydrin and the formula (I) compound are partially segregated or totally segregated.

13. The bio-sourced cationic polymer according to claim 1, wherein the epihalohydrin and the formula (I) compound are at least partially, or totally derived from a recycling method.

14. The bio-sourced cationic polymer according to claim 1, wherein the bio-sourced cationic polymer has a charge density between 4 and 7 meq/g.

15. The bio-sourced cationic polymer according to claim 1, wherein the bio-sourced cationic polymer is obtained according to a method comprising: epihalohydrin and the formula (I) compound react at a temperature ranging between 5 and 95° ° C., the product of this reaction being a formula (I) compound adduct—cpihalohydrin, followed by a process wherein said adduct is polymerized at a temperature ranging between 5 and 95° C. to form a bio-sourced cationic polymer.

16. The bio-sourced cationic polymer according to claim 1, wherein the bio-sourced cationic polymer is linear or branched.

17. The bio-sourced cationic polymer according to claim 1, wherein the bio-sourced cationic polymer is a bio-sourced polyamine obtained from epihalohydrin that is least partially renewable and non-fossil, and at least one mixture of dimethylamine that is least partially renewable and non-fossil, and ethylenediamine that is at least partially renewable and non-fossil, the molar percentage, expressed relative to the total amount of dimethylamine and ethylenediamine being:
at least 90% dimethylamine, and
10% or less of ethylene diamine.

18. The bio-sourced cationic polymer according to claim 1, wherein the bio-sourced cationic polymer is obtained according to a method comprising:
recycling at least one material that is at least partially renewable and non-fossil to obtain epihalohydrin and the formula (I) compound,
reacting the epihalohydrin and the formula (I) compound at a temperature ranging between 5 and 95° ° C., the product of this reaction being a formula (I) compound adduct—epihalohydrin,
polymerizing said adduct obtained at a temperature ranging between 5 and 95° C., to obtain the bio-sourced cationic polymer.

19. A method for obtaining a bio-sourced cationic polymer by reaction of epihalohydrin that is at least partially renewable and non-fossil and at least one formula (I) compound that is at least partially renewable and non-fossil, 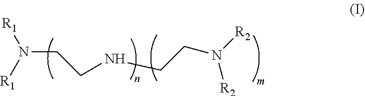
such that:
R₁ and R₂ are, independently of each other, a hydrogen atom H or an alkyl chain comprising 1 to 8 carbon atoms,
n=0 to 3, m=0 or 1, and where n=m=0, then a hydrogen atom H is covalently bonded to the nitrogen atom N of the NR₁R₁ group.

20. (canceled)

21. (canceled)

22. A method of inerting clays in hydraulic compositions for construction purposes, said method comprising: adding to the hydraulic composition or one of its constituents at least one clay inerting agent, wherein the clay inerting agent is a polymer according to claim 1.
